(19) United States
(12) Patent Application Publication
(10) Pub. No.: US 2024/0240073 A1
(43) Pub. Date: Jul. 18, 2024

(54) THERMAL INSULATING FLUIDS

(71) Applicant: Omnova Solutions, Inc., Beachwood, OH (US)

(72) Inventor: KAMAL SAID KAMAL ELSAYED, Stafford, TX (US)

(73) Assignee: Omnova Solutions, Inc., Beachwood, OH (US)

(21) Appl. No.: 18/532,622

(22) Filed: Dec. 7, 2023

Related U.S. Application Data
(60) Provisional application No. 63/434,140, filed on Dec. 21, 2022.

(51) Int. Cl. C09K 8/82; C09K 8/88; E21B 36/00

(52) U.S. Cl. CPC C09K 8/82; C09K 8/882; E21B 36/003

(57) ABSTRACT

A thermal insulating fluid is described that comprises (a) a styrenic-acrylic polymeric rheological modifier; (b) a hydrocarbon fluid; (c) optionally a first emulsifier; (d) optionally an inorganic salt; (e) optionally an alkaline source; (f) optionally a second emulsifier; and (g) optionally an aqueous phase, wherein the thermal insulating fluid is a yield power law fluid. A process for preparing the thermal insulating fluid and uses thereof are also described.

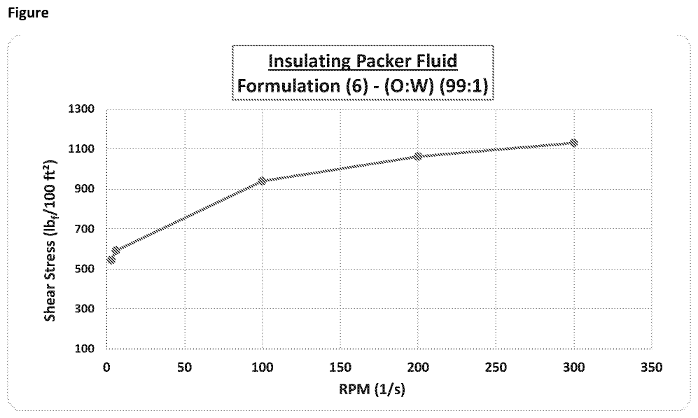

This application is a non-provisional application claiming the benefit of priority to U.S. Provisional Application No. 63/434,140 filed Dec. 21, 2022, the disclosure of which is incorporated herein by reference in its entirety for all purposes.

### BACKGROUND OF THE INVENTION

In cold-temperature environments such as the arctic and deep water, wells may experience several production problems, like wax build-up, hydrate formation, and salt deposition, resulting from the poor thermal insulation between the production tubing and the annulus of the well. In geothermal wells, heat loss to the annulus before thermal fluids reach surface reduces the efficiency of the geothermal well. In steam injection wells, the loss of heat into non-targeted zones through annular heat losses reduces the efficiency of the steam used for production. The loss of heat also negatively impacts the previously established well integrity. As a result, the demands are increased for high performance/high temperature insulating packer fluids systems.

An important feature of a drilling fluid is its rheology, especially as it relates to drilling and circulation of the fluid through the well. In particular, the drilling fluid should be sufficiently viscous to suspend drilled cuttings and to carry the cuttings to the well surface. However, the fluid should not be so viscous as to interfere with the drilling operation.

The Herschel-Bulkley equation (also known as the Yield Power Law Equation) below is used to

$$T = {T}_{y} + {k}_{m} {γ}^{{n}_{m}}$$

describe the rheological behavior of certain non-Newtonian fluids in which the strain experienced by the fluid is related to the stress in a non-linear way, where T is the shear stress (lb_{f}/100 ft²), T_{γ} is the yield stress (lb_{f}/100 ft²), kₘ is the consistency factor, γ is the shear rate (s⁻¹) and nₘ is the flow behavior index.

The viscosity of a fluid is its internal resistance to flow. The coefficient of viscosity of a normal homogeneous fluid (referred to as a Newtonian fluid) at a given temperature and pressure is a constant for that fluid and independent of the rate of shear or the velocity gradient. In fluids referred to as non-Newtonian fluids, this coefficient is not constant but is instead a function of the rate at which the fluid is sheared as well as of the relative concentration of the phases. The thermal insulation fluids of the invention are generally non-Newtonian fluids. The rate of flow change, known as plastic viscosity (PV), is analogous to viscosity in Newtonian fluids.

Conventional thermal insulating fluids reduce the previously identified problems by controlling the heat conduction and heat convection between the annulus and the production tubing in the well. In geothermal wells and steam injection wells, conventional thermal insulating fluids and/or well configurations are used to reduce the heat transfer from the wellbore to the formation. However, these thermal insulating fluids have the drawbacks of limited performance, complicated mixing procedures requiring specialized equipment, and/or high activation temperatures. See, e.g., U.S. Pat. No. 8,236,736.

The present invention has the advantage of providing a thermal insulating fluid (i.e., a fluid which possesses low thermal conductivity and resists the transfer of heat, both to and from other materials) which has the required special rheological characteristics of a yield stress value within an impactful range by using a polymeric rheological modifier.

### SUMMARY OF THE INVENTION

An aspect of the invention is a thermal insulating fluid comprising (a) a styrenic-acrylic polymeric rheological modifier; (b) a hydrocarbon fluid; (c) optionally a first emulsifier; (d) optionally an inorganic salt; (e) optionally an alkaline source; (f) optionally a second emulsifier; and (g) optionally an aqueous phase, wherein the thermal insulating fluid is a yield power law fluid.

In an exemplary embodiment, the styrenic-acrylic polymeric rheological modifier contains a styrene-based monomer substituted on the phenyl moiety, chosen from meta-methyl-styrene, para-methyl-styrene, para-propyl-styrene, para-tert-butyl-styrene, para-cyclohexyl-styrene, para-dodecyl-styrene, 2-ethyl-4-benzyl-styrene, para-(phenylbutyl)-styrene, and mixtures thereof.

Another aspect of the invention is a method for preparing a thermal insulating fluid, comprising combining (a) a styrenic-acrylic polymeric rheological modifier; (b) a hydrocarbon fluid; (c) optionally a first emulsifier; (d) optionally an inorganic salt; (e) optionally an alkaline source; and (f) optionally a second emulsifier; optionally heating the resulting mixture; and shearing the mixture.

Another aspect of the invention is a method for adding a thermal insulating fluid into an annulus, comprising preparing the thermal insulating fluid; and pumping the thermal insulating fluid into one or more annuli. In an exemplary embodiment, an annulus is provided between a first tubing and a second tubing; and the thermal insulating fluid is placed in the annulus. In another embodiment, a tubing containing a first fluid located within a wellbore is provided such that an annulus is formed between the tubing and a surface of the wellbore; and the thermal insulating fluid is placed in the annulus. In another embodiment, a first tubing is provided that comprises at least a portion of a pipeline that contains a first fluid; a second tubing is provided that substantially surrounds the first tubing to create an annulus between the first tubing and the second tubing; and the thermal insulating fluid is placed in the annulus.

Another aspect of the invention is an annulus of a well containing a thermal insulating fluid of the invention. In an exemplary embodiment, the thermal insulating fluid is placed in the annulus between the tubing and the casing and may be disposed above a packer.

In an exemplary embodiment, the thermal insulating fluid is oil-based and does not contain an aqueous phase.

In an exemplary embodiment, the thermal insulating fluid contains an aqueous phase.

In an exemplary embodiment, the thermal insulating fluid contains an aqueous phase and an emulsifier.

In an exemplary embodiment, the thermal insulating fluid comprises (a) a styrenic-acrylic polymeric rheological modifier; (b) a hydrocarbon fluid; (c) a first emulsifier; (d) optionally an inorganic salt; (e) optionally an alkaline source; (f) optionally a second emulsifier; and (g) an aqueous phase.

In an exemplary embodiment, the thermal insulating fluid comprises (a) a styrenic-acrylic polymeric rheological modifier; (b) a hydrocarbon fluid; (c) a first emulsifier; (d) an inorganic salt; (e) optionally an alkaline source; (f) optionally a second emulsifier; and (g) an aqueous phase.

In an exemplary embodiment, the thermal insulating fluid comprises (a) a styrenic-acrylic polymeric rheological modifier; (b) a hydrocarbon fluid; (c) a first emulsifier; (d) an inorganic salt; (e) an alkaline source; and (g) an aqueous phase.

In an exemplary embodiment, the thermal insulating fluid consists essentially of (a) a styrenic-acrylic polymeric rheological modifier; (b) a hydrocarbon fluid; (c) a first emulsifier; (d) an inorganic salt; (e) an alkaline source; and (g) an aqueous phase.

In an exemplary embodiment, the thermal insulating fluid consists of (a) a styrenic-acrylic polymeric rheological modifier; (b) a hydrocarbon fluid; (c) a first emulsifier; (d) an inorganic salt; (e) an alkaline source; and (g) an aqueous phase.

In an exemplary embodiment, the thermal insulating fluid comprises (a) a styrenic-acrylic polymeric rheological modifier; (b) a hydrocarbon fluid; (c) optionally a first emulsifier; (d) optionally an inorganic salt; (e) optionally an alkaline source; (f) optionally a second emulsifier, and where the thermal insulating fluid does not contain an aqueous phase.

In an exemplary embodiment, the thermal insulating fluid comprises (a) a styrenic-acrylic polymeric rheological modifier; (b) a hydrocarbon fluid; (c) a first emulsifier; (d) optionally an inorganic salt; (e) optionally an alkaline source; (f) optionally a second emulsifier, and where the thermal insulating fluid does not contain an aqueous phase.

In an exemplary embodiment, the thermal insulating fluid comprises (a) a styrenic-acrylic polymeric rheological modifier; (b) a hydrocarbon fluid; (d) an inorganic salt; and (e) optionally an alkaline source, and where the thermal insulating fluid does not contain an aqueous phase.

In an exemplary embodiment, the thermal insulating fluid comprises (a) a styrenic-acrylic polymeric rheological modifier; (b) a hydrocarbon fluid; (d) an inorganic salt; and (e) an alkaline source, and where the thermal insulating fluid does not contain an aqueous phase.

In an exemplary embodiment, the thermal insulating fluid consists essentially of (a) a styrenic-acrylic polymeric rheological modifier; (b) a hydrocarbon fluid; (d) an inorganic salt; and (e) an alkaline source, and where the thermal insulating fluid does not contain an aqueous phase.

In an exemplary embodiment, the thermal insulating fluid consists of (a) a styrenic-acrylic polymeric rheological modifier; (b) a hydrocarbon fluid; (d) an inorganic salt; and (e) an alkaline source, and where the thermal insulating fluid does not contain an aqueous phase.

In an exemplary embodiment, the styrenic-acrylic polymeric rheological modifier is present in an amount of at least 10 vol % relative to the total volume of the thermal insulating fluid.

In an exemplary embodiment, the styrenic-acrylic polymeric rheological modifier is present in an amount of at least 20 vol % relative to the total volume of the thermal insulating fluid.

In an exemplary embodiment, the styrenic-acrylic polymeric rheological modifier is present in an amount of at least 50 vol % relative to the total volume of the thermal insulating fluid.

In an exemplary embodiment, the styrenic-acrylic polymeric rheological modifier exhibits one or more, such as two or more, such as three or more, such as four or more of the following properties: it swells in the presence of oil; it is hydrophobic at its surface and interacts with both oil and water phases; it has substantial insulating properties due to showing a yield stress of at least 10 lb_{f}/100 ft² (5 Pa); it minimizes convective heat loss; and it can sustain a high oil:water ratio.

In an exemplary embodiment, the styrenic-acrylic polymeric rheological modifier is a styrenic-acrylic copolymer. In an exemplary embodiment, the styrenic-acrylic copolymer is crosslinked.

In an exemplary embodiment, the styrenic-acrylic polymeric rheological modifier is a styrenic-acrylic copolymer containing a styrene-based monomer chosen from para-tert-butyl-styrene (PTBS), para-methyl-styrene (PMS), or a mixture thereof.

In an exemplary embodiment, the aqueous phase is present in an amount of at least 1 and 30 vol % relative to the total volume of the thermal insulating fluid.

In an exemplary embodiment, the inorganic salt is an alkali salt or an alkaline earth salt. In an exemplary embodiment, the inorganic salt is a sodium salt, a potassium salt or a calcium salt. In a particular embodiment, the inorganic salt is a calcium salt. In an exemplary embodiment is selected from calcium hydroxide (Ca(OH)₂) and calcium chloride (CaCl₂).

In an exemplary embodiment, the thermal insulating fluid is effective at room temperature and does not require heat activation.

In an exemplary embodiment, the thermal insulating fluid according to the invention further comprises an organoclay.

In an exemplary embodiment, the thermal insulating fluid according to the invention is free of organoclays.

In an exemplary embodiment, the thermal insulating fluid is substantially free of solids.

In an exemplary embodiment, the thermal insulating fluid further comprises one or more additives selected from weighting agents, wetting agents, fluid loss control additives, lost circulation materials (LCM), lubricants, temperature extenders, corrosion inhibitors, hydrogen sulfide (H₂S) scavengers, carbon dioxide (CO₂) scavengers, oxygen (O₂) scavengers, biocides, scale inhibitors and alkalinity regulators.

In an exemplary embodiment of a method for preparing a thermal insulating fluid of the invention, the hydrocarbon fluid is added first before the other components.

### BRIEF DESCRIPTION OF THE DRAWINGS

The following FIGURE represents particular embodiment of the invention and is not intended to otherwise limit the scope of the invention as described herein.

The FIGURE shows the shear stress results associated with Formulation 6.

### DETAILED DESCRIPTION OF THE INVENTION

The thermal insulating fluid of the invention prevents or reduces the previously mentioned production problems (e.g., wax build-up, hydrate formation and salt deposition) by controlling the heat conduction and heat convection between the annulus and the production tubing in the well. These achievements are possible because the thermal insulating fluid is associated with several advantageous properties: the ability to achieve the rheological characteristic (a yield stress of greater than 10 pounds force per square foot (i.e., 10 lb_{f}/100 ft² or approximately 5 Pa) required for effective thermal insulation, no need for a crosslinker to build high viscosity, no heat activation required, resolves the long-term settling issues associated with conventional systems, thermally stable to approximately 400° F. (approximately 204° C.), exhibits a low corrosion profile characteristic of oil-based systems versus water-based systems, is an easily mixed liquid form that avoids the need for specialized mixing equipment.

In an exemplary embodiment, the thermal insulating fluid of the invention maintains a gel-form structure after static thermal aging for 16 hours at 400° F. (approximately 204° C.). In an exemplary embodiment, the amount of the rheology modifier is between 10 to 25%, such as 12 to 25% such as 15 to 25%, such as 15 to 20%, by volume compared to the total volume of the thermal insulating fluid.

In an exemplary embodiment, changing the relative amounts between any primary and secondary emulsifiers that are present in the thermal insulating fluid had minimal or no impact on the thermal stability of the thermal insulating fluid.

In an exemplary embodiment, the thermal insulating fluid showed no reduction in viscosity over an extended time (e.g., as up to 2 days, such as up to 4 days, such as up to 6 days) at ambient temperature (e.g., approximately 70° F. (approximately 21° C.)).

In an exemplary embodiment, the activation time of the thermal insulating fluid (when containing an aqueous phase) was significantly extended by changing the oil:water ratio from 95:5 to 99:1. In an exemplary embodiment, the activation time was extended by at least 50%, such as at least 100%, such as at least 200%, such as at least 300%, such as up to 500%.

In an exemplary embodiment, the activation time of the thermal insulating fluid was extended by reducing the mixing shear revolutions per minute (rpm). In a particular embodiment, the activation time of the thermal insulating fluid was significantly extended by reducing the mixing shear rpm from 11.5K to 0.5K. In an exemplary embodiment, the activation time was extended by at least 100% by reducing the mixing shear rpm, such as by at least 300%, such as by at least by 500%, such as by at least 750%, such as by at least 1000%, such as by at least 1500%, such as up to 2000%.

The invention is relevant to any application that requires a thermal insulating fluid, such as an insulating packer fluid. Conventional packer fluids include (i) brine, which has the limitation of poor thermal insulation and severe corrosion impact; (ii) gelled brines (with a crosslinker and viscosifier), which in addition to the noted limitations associated with brine also frequently has complicated mixing procedures; and (iii) oil-based systems (with a solid polymeric viscosifier), which requires heat activation and high shear mixing equipment to disperse the polymer.

The thermal insulating fluid of the invention is a yield power law fluid (i.e., it exhibits a yield stress of T_{γ}≠0 as described by the Herschel-Bulkley equation), with a yield stress value greater than 0 lb_{f}/100 ft², such as greater than 10 lb_{f}/100 ft² (i.e., greater than 5 Pa), which indicates that the fluid has sufficient resistance to minimize the convectional currents, which results in substantial thermal insulation. In fact, yield stress is an important parameter with regards to being able to prevent convection, i.e., the resistance a fluid has against starting to move. In an exemplary embodiment, the thermal insulating fluid of the invention exhibits a yield stress of higher than 20 lb_{f}/100 ft² (approximately 9.6 Pa), such as higher than 30 lb_{f}/100 ft² (approximately 14.4 Pa), such as higher than 40 lb_{f}/100 ft² (approximately 19.2 Pa), such as higher than 50 lb_{f}/100 ft² (approximately 23.9 Pa), such as higher than 55 lb_{f}/100 ft² (approximately 26.3 Pa), such as higher than 60 lb_{f}/100 ft² (approximately 28.7 Pa), such as higher than 65 lb_{f}/100 ft² (approximately 31.1 Pa), such as higher than 70 lb_{f}/100 ft² (approximately 33.5 Pa), such as between 30 and 105 lb_{f}/100 ft² (approximately 14.4 to approximately 50.3 Pa), such as between 40 and 100 lb_{f}/100 ft² (approximately 19.2 to approximately 47.9 Pa), such as between 50 and 90 lb_{f}/100 ft² (approximately 23.9 to approximately 43.1 Pa), such as between 55 and 90 lb_{f}/100 ft² (approximately 26.3 to approximately 43.1 Pa), such as between 60 and 90 lb_{f}/100 ft² (approximately 28.7 to approximately 43.1 Pa), such as between 65 and 90 lb_{f}/100 ft² (approximately 31.1 to approximately 43.1 Pa).

In an exemplary embodiment, the thermal insulating fluid of the invention is a yield power law fluid having a viscosity that increases as shear-strain rates diminish. As control over heat loss due to convection is developed, the shear-rate environment drops and viscosity of the yield power law fluid increases, reducing convective heat loss further. A yield power law fluid also typically has a relatively low high-shear-rate viscosity, making it easier to place and displace. See, e.g., R. L. Horton et al., A New Yield Power Law Analysis Tool Improves Insulating Annular Fluid Design, IPTC 10006, 1-20 (2005).

The thermal insulating fluid of the invention may come into contact with any of a number of components, such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

In an exemplary embodiment, the thermal insulating fluid is formed at a well-site location, at a pipeline location, or off-site and transported to a selected site for use.

### Styrenic-Acrylic Polymeric Rheological Modifier

Rheological modifiers are known in the art. See, e.g., U.S. patent Ser. No. 11/041,107. In an exemplary embodiment, the styrenic-acrylic polymeric rheological modifier is obtained by polymerization of the following monomers: (a) at least one styrene-based monomer; (b) at least one (meth)acrylate-based monomer; and c) optionally a copolymerizable surfactant containing an optionally substituted vinyl function and moieties derived from propylene oxide and/or ethylene oxide, optionally in the presence of a non-polymerizable surfactant containing moieties derived from propylene oxide and/or ethylene oxide, and optionally in the presence of another surfactant, wherein at least the copolymerizable surfactant or the non-polymerizable surfactant is present during the polymerization process.

It should be noted that, when a non-polymerizable surfactant is present, it is important that this non-polymerizable surfactant is present during the polymerization step, even if it does not react with the monomers, since the simple admixture of a polymer obtained by polymerization of monomers (a) and (b) with the non-polymerizable surfactant does not give a styrenic-acrylic polymeric rheological modifier having the desired properties.

The terms “(C₁-C₂₅)alkyl”, “(C₁-C₁₅)alkyl” and “(C₁-C₆)alkyl”, as used in the present invention, refer to a straight or branched monovalent saturated hydrocarbon chain containing respectively 1 to 25, 1 to 15 or 1 to 6 carbon atoms including, but not limited to, methyl, ethyl, n-propyl, iso-propyl, n-butyl, iso-butyl, sec-butyl, t-butyl, n-pentyl, n-hexyl, dodecyl and the like.

The term “(C₁-C₆)alkanediyl”, as used in the present invention, refers to a straight or branched divalent saturated hydrocarbon chain containing from 1 to 6 carbon atoms including, but not limited to, methanediyl, ethanediyl, propanediyl, butanediyl, pentanediyl, hexanediyl, and the like.

The term “(C₂-C₆)alkenyl”, as used in the present invention, refers to a straight or branched unsaturated hydrocarbon chain containing from 2 to 6 carbon atoms and comprising at least one double bond including, but not limited to, vinyl, propenyl, butenyl, pentenyl, hexenyl and the like. In an exemplary embodiment, the (C₂-C₆)alkenyl is a vinyl group.

The term “(C₅-C₈)cycloalkyl”, as used in the present invention, refers to a saturated hydrocarbon ring having 5 to 8 carbon atoms including, but not limited to, cyclopentyl, cyclohexyl and the like.

The term “aryl”, as used in the present invention, refers to an aromatic group comprising preferably 6 to 10 carbon atoms and comprising one or more fused rings, such as, for example, a phenyl or naphtyl group. In an exemplary embodiment, the aryl group is a phenyl group.

The term “aryl-(C₁-C₆)alkyl”, as used in the present invention, refers to an aryl group as defined above bound to the molecule via a (C₁-C₆)alkyl group as defined above. In an exemplary embodiment, the aryl-(C₁-C₆)alkyl group is a benzyl or phenylbutyl group.

The term “optionally substituted vinyl function”, as used in the present invention, refers to a group —CHR═CHR′ in which R and R′ represent, independently of each other, a hydrogen atom or a substituent such as a (C₁-C₂₅)alkyl, in particular a (C₁-C₆)alkyl, notably a methyl. It can be advantageously a group —CHR=CH₂ with R representing a (C₁-C₆)alkyl, notably a methyl. In an exemplary embodiment, the vinyl function is —CH═CH₂ or —CMe=CH₂.

The term “moieties derived from propylene oxide and/or ethylene oxide”, as used in the present invention, refers to a group of the following formula:

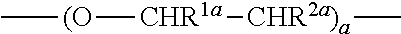

wherein each R^{1a} and each R^{2a} represent, independently of each other, a hydrogen atom or a methyl group but R^{1a} and R^{2a} cannot both represent a methyl group; and “a” represents an integer of at least 1, notably at least 3.

When the surfactant concerned is a copolymerizable surfactant, “a” advantageously represents an integer of at least 3, such as between 3 and 120, such as between 5 and 70, such as between 5 and 40. When the surfactant is a non-polymerizable surfactant, “a” advantageously represents an integer between 1 and 60, such as between 3 and 20.

Thus, the moieties —(O—CHR^{1a}—CHR^{2a})— represent moieties derived either from ethylene oxide (OCH₂CH₂) or from propylene oxide (OCH₂CHMe or OCHMeCH₂). In an exemplary embodiment, the group is of the following formula:

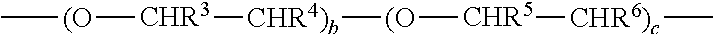

wherein “b” and “c” each represents, independently of each other, an integer above or equal to 0, with b+c≥1, notably b+c≥3; R³ and R⁴ each represents, independently of each other, a hydrogen atom or a methyl group but cannot both represent a methyl group; and R⁶ and R⁵ each represents, independently of each other, a hydrogen atom or a methyl group but cannot both represent a methyl group.

When the surfactant concerned is a copolymerizable surfactant, “b” and “c” each advantageously represents, independently of each other, an integer greater than or equal to 0, with b+c≥3, such as 3≤b+c≤120, such as 3≤b+c≤70, such as 5≤b+c≤40. When the surfactant is a non-polymerizable surfactant, “b” and “c” each advantageously represents, independently of each other, an integer greater than or equal to 0, with b+c≥1, such as 1≤b+c≤60, such as 3≤b+c≤20.

The moieties —(O—CHR³—CHR⁴)_{b}— and —(O—CHR⁵—CHR⁶)_{c}— represent then either a polyethylene oxide (PEO) moiety, i.e., (OCH₂CH₂)ₓ with x=b or c, or a polypropylene oxide (PPO) moiety, i.e., (OCH₂CHMe)_{y} or (OCHMeCH₂)_{y} with y=b or c.

The term “styrene-based monomer” refers to a monomer containing a styrene moiety optionally substituted, preferably on the phenyl moiety, such as at the para position, with one or more substituents. The substituent can be a (C₁-C₁₅)alkyl, such as a (C₁-C₆)alkyl, a (C₂-C₆)alkenyl, a (C₅-C₈)cycloalkyl, an aryl or an aryl-(C₁-C₆)alkyl. In an exemplary embodiment, the styrene-based monomer is a (C₁-C₆)alkyl-styrene, and notably a para-(C₁-C₆)alkyl-styrene.

The styrene-based monomer includes, but is not limited to, styrene, meta-methyl-styrene, para-methyl-styrene, para-propyl-styrene, para-tert-butyl-styrene, para-cyclohexyl-styrene, para-dodecyl-styrene, 2-ethyl-4-benzyl-styrene, para-(phenylbutyl)-styrene, divinylbenzene and mixtures thereof. In particular, it can be para-tert-butyl-styrene (PTBS), para-methyl-styrene (PMS) and mixtures thereof.

The term “(meth)acrylate” is well known to the person skilled in the art and refers both to methacrylate and acrylate derivatives.

The term “(meth)acrylate-based monomer” refers thus to a monomer containing a (meth)acrylate moiety, i.e., a methacrylate or acrylate moiety. This (meth)acrylate moiety can correspond to the following formula:

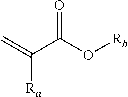

wherein Rₐ represents a hydrogen atom or a methyl group; and R_{b} represents a (C₁-C₁₅) hydrocarbon group, such as a (C₁-C₁₀) saturated hydrocarbon group. The saturated hydrocarbon group can be straight or branched, and thus represents a (C₁-C₁₅)alkyl, such as a (C₁-C₁₀)alkyl group. The saturated hydrocarbon group can also be mono- or poly-cyclic, the cyclic groups advantageously being 5- or 6-membered rings and being optionally substituted with one or more (C₁-C₄)alkyl groups.

The (meth)acrylate-based monomer includes, but is not limited to, ethyl acrylate, n-propyl acrylate, isopropyl acrylate, n-butyl acrylate, tert-butyl acrylate, pentyl acrylate, hexyl acrylate, 2-ethylhexyl acrylate, methyl methacrylate, n-butyl methacrylate, isobutyl methacrylate, 2-ethylhexyl methacrylate, lauryl methacrylate, isobornyl methacrylate and mixtures thereof.

In an exemplary embodiment, monomer (b) is at least one chosen from isobornyl methacrylate (IBOMA), isobornyl acrylate (IBOA), isobutyl methacrylate (IBMA), 2-ethylhexyl acrylate (2EHA) and mixtures thereof. In a particular embodiment, monomer (b) is chosen from isobornyl methacrylate (IBOMA), isobutyl methacrylate (IBMA), 2-ethylhexyl acrylate (2EHA) and mixtures thereof. In a specific embodiment, monomer (b) is IBOMA.

In an exemplary embodiment, the ratio by weight of monomer (a) to monomer (b) is between 95:5 and 10:90, such as between 95:5 and 50:50, and notably between 95:5 and 70:30.

In an exemplary embodiment, the styrenic-acrylic polymeric rheological modifier is a styrenic-acrylic copolymer containing a styrene-based monomer chosen from para-tert-butyl-styrene (PTBS), para-methyl-styrene (PMS), or a mixture thereof.

The term “copolymerizable surfactant” means that the surfactant contains a functional group which can react with a functional group of the monomers (a) and/or (b) during the polymerization step to form a polymer, i.e., an optionally substituted vinyl function. Such a copolymerizable surfactant is preferably an anionic or non-ionic surfactant carrying an optionally substituted vinyl functionality and moieties derived from propylene oxide and/or ethylene oxide. The vinyl functionality is advantageously optionally substituted with a (C₁-C₂₅)alkyl, such as a (C₁-C₆)alkyl, such as a methyl. Such a surfactant can thus correspond to the following formula:

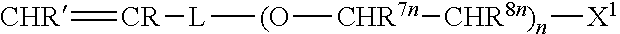

wherein L represents a single bond or a linker; R and R′ represent, independently of each other, H or a (C₁-C₂₅)alkyl, such as H or a (C₁-C₆)alkyl, such as H or a methyl, preferably H; “n” represents an integer of at least 1, such as an integer between 3 and 120, such as between 5 and 70, such as between 5 and 40; each R⁷ⁿ and each R⁸ⁿ represent, independently of each other, a hydrogen atom or a methyl group but R⁷ⁿ and R⁸ⁿ cannot both represent a methyl group; and X¹ represents —O-(optionally substituted aryl), —O—(C₁-C₂₅)alkyl, —O—(C₁-C₆)alkanediyl-SO₃H, —OH (alcohol), —S(O)₂(OH) (sulfonate), —O—P(O)(OH)₂ (phosphate) or —O—S(O)₂(OH) (sulfate) group, or a salt thereof, such as a sodium, potassium or ammonium salt.

Thus, the moieties —(O—CHR⁷ⁿ—CHR⁸ⁿ)— represent moieties derived either from ethylene oxide (OCH₂CH₂) or from propylene oxide (OCH₂CHMe or OCHMeCH₂).

The term “linker” refers to a divalent group (generally a small group) used to link the “vinyl” moiety —CR═CHR′ to the rest of the surfactant such as, but not limited to, a (C₁-C₆)alkanediyl, such as —(CH₂)ₖ— (k=1 to 6, notably 1), —C(═O)—, —O—(C₁-C₁₅)alkanediyl, such as —O—(CH₂)ₜ— (t=1 to 6), —O-aryl optionally substituted with a (C₁-C₁₅)alkyl,

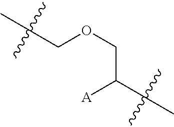

where A=(C₁-C₁₅)alkyl or (CH₂)ᵤOA¹ with A¹ representing a hydrocarbon chain and u=1 to 6, notably 1. The linker can be also a polyol optionally substituted.

In an exemplary embodiment, X¹ in the above formula represents —OH (alcohol), —S(O)₂(OH) (sulfonate), —O—P(O)(OH)₂ (phosphate) or —O—S(O)₂(OH) (sulfate) group, or a salt thereof, such as a sodium, potassium or ammonium salt.

In an exemplary embodiment, R′═H and R═H or (C₁-C₆)alkyl, notably H or methyl, preferably H.

The aryl moiety of X¹ is preferably a phenyl. This aryl moiety can be optionally substituted in particular with one or several groups chosen from (C₁-C₆)alkyl, aryl and aryl-(C₁-C₆)alkyl.

The copolymerizable surfactant can correspond in particular to the following formula:

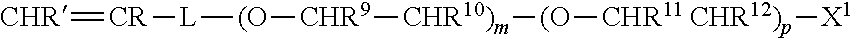

wherein R, R′, L and X¹ are as defined above; “m” and “p” each represents, independently of each other, an integer greater than or equal to 0, with m+p≥3, such as 3≤m+p<120, such as 3≤m+p<70, such as 5≤m+p<40; R⁹ and R¹⁰ each represents, independently of each other, a hydrogen atom or a methyl group but cannot both represent a methyl group; and R¹¹ and R¹² each represents, independently of each other, a hydrogen atom or a methyl group but cannot both represent a methyl group.

Thus, the moieties —(O—CHR⁹—CHR¹⁰)ₘ— and —(O—CHR¹¹—CHR¹²)ₚ— represent either a polyethylene oxide (PEO) moiety, i.e., (OCH₂CH₂)ₓ with x=m or p, or a polypropylene oxide (PPO) moiety, i.e., (OCH₂CHMe)_{y} or (OCHMeCH₂)_{y} with y=m or P.

In various exemplary embodiments, the copolymerizable surfactant of the above formula is selected from one or more of the following compounds.

| Compound | Trade name |
|---|---|
| 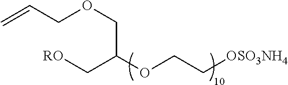 | Reasoap ® SR-10 (sold by Adeka) |
| with R representing a hydrocarbon chain | |
| 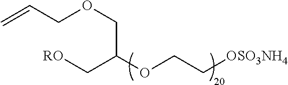 | Reasoap ® SR-20 (sold by Adeka) |
| with R representing a hydrocarbon chain | |
| 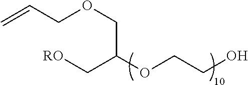 | Reasoap ® ER-10 (sold by Adeka) |
| with R representing a hydrocarbon chain | |
| 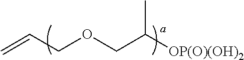 | Reasoap ® PP-70 (sold by Adeka) |
| 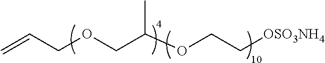 | Emulsogen ® APS 100 (sold by Clariant) |

The term “non-polymerizable surfactant” means that the surfactant contains no functionality which can react with monomers (a) and (b) to form the polymer and thus that this surfactant will not be covalently linked to the polymer formed during the polymerization step.

Such a non-polymerizable surfactant is preferably an anionic or non-ionic surfactant containing moieties derived from propylene oxide and/or ethylene oxide, and in particular derived from ethylene oxide. Such a surfactant can correspond to the following formula:

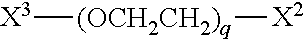

wherein “q” represents an integer comprised between 1 and 60, such as between 3 and 20; X³ represents a (C₈-C₂₅)alkyl chain, i.e., a straight or branched saturated hydrocarbon chain containing 8 to 25 carbon atoms, or an aryl (such as a phenyl) optionally substituted with a (C₁-C₂₅)alkyl; and X² represents —OH (alcohol), —S(O)₂(OH) (sulfonate), —O—P(O)(OH)₂ (phosphate) or —O—S(O)₂(OH) (sulfate) group, or a salt thereof, such as a sodium, potassium or ammonium salt. In an exemplary embodiment, X³ is a (C₈-C₂₅)alkyl chain.

In various exemplary embodiments, the non-polymerizable surfactant of the above formula is chosen from one or more of the following compounds.

| Compound | Trade name |
|---|---|
| 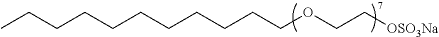 | Emulsogen ® EPA 073 (sold by Clariant) |
| 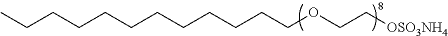 | Ealsogen ® LA 083 (sold by Adeka) |
| 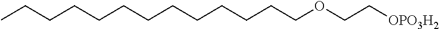 | Rhodafac ® RS-610 A25 (sold by Rhodia) |
| 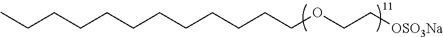 | Disponil ® FBS993 (sold by Cognis) |

The copolymerizable surfactant and the non-polymerizable surfactant have to be present during the polymerization step.

In an exemplary embodiment, the styrenic-acrylic polymeric rheological modifier comprises at least one copolymerizable surfactant. Indeed, the styrenic-acrylic polymeric rheological modifier thus obtained has improved rheological properties. Advantageously, the rheological agent will comprise 0.5 to 10 wt %, such as 1 to 7 wt %, of copolymerizable and non-polymerizable surfactants relatively to the total weight of the styrenic-acrylic polymeric rheological modifier on a dry basis (i.e., to the active parts of the rheological modifier).

The polymerization reaction is carried out under conditions well known to the person skilled in the art, notably under conditions of emulsion polymerization. In particular, the reaction can be carried out in the presence of a crosslinking agent, such as divinyl benzene or ethylene glycol dimethacrylate. The crosslinking agent represents 0 to 5 wt %, such as 0.01 to 3 wt %, of the total weight of the styrenic-acrylic polymeric rheological modifier. The rheological modifier can thus be in the form of a crosslinked polymer.

According to an exemplary embodiment, the styrenic-acrylic polymeric rheological modifier is in the form of a statistical copolymer, optionally crosslinked.

The term “statistical copolymer”, as used in the present invention, refers to a copolymer in which the sequence of monomer residues follows a statistical rule.

The polymerization reaction may be carried out in the presence of another surfactant which can be a surfactant commonly used in an emulsion polymerization reaction.

In an exemplary embodiment, the styrenic-acrylic polymeric rheological modifier is present in an amount of at least 10 vol %, such as at least 15 vol %, such as at least 20 vol %, such as at least 25 vol %, such as at least 30 vol %, such as at least 35 vol %, such as at least 40 vol %, such as at least 50 vol %, such as between 10 to 50 vol %, such as between 10 to 40 vol %, such a between 15 to 50 vol %, such as between 15 to 40 vol %, relative to the total volume of the thermal insulating fluid.

### Hydrocarbon Fluid

Suitable hydrocarbon fluids are not particularly limited, and include, but are not limited to, diesels, paraffin oils, mineral oils, crude oils, kerosene, or mixtures thereof. The hydrocarbon fluids may range from those of high aromaticity (e.g., diesels) to those of low aromaticity (e.g., paraffin oils formed of isoalkanes and cycloalkanes). See, e.g., U.S. Pat. No. 7,056,869.

Hydrocarbon fluids can be classified as, for example, paraffinic, isoparaffinic, dearomatized, naphthenic, non-dearomatized and aromatic.

In an exemplary embodiment, the hydrocarbon fluid is Escaid™ 110 (a mineral oil) (sold by ExxonMobil).

### Emulsifier

Suitable emulsifiers are not particularly limited, and include emulsifiers commonly used in an emulsion polymerization reaction, such as, but not limited to, rosin acids, tall oil acids, fatty alcohols, or fatty acids, salts thereof and derivatives thereof (such as amidoamines, polyamides, alkanolamides, polyamines, esters, imidaxolines, sulfates and phosphonates) and synthetic emulsifiers.

In an exemplary embodiment, the emulsifier also functions as a wetting agent.

In an exemplary embodiment, the emulsifier is selected from one or more of the commercial PINEMUL® emulsifiers, such as selected from PINEMUL® 100 (modified oxidized tall oil) (sold by Mobile Rosin Oil Company), PINEMUL® 101 (modified tall oil) (sold by Mobile Rosin Oil Company), PINEMUL® 102 (modified fatty acid) (sold by Mobile Rosin Oil Company), PINEMUL® 200 (modified alkyl polyamide in mineral oil) (sold by Mobile Rosin Oil Company), PINEMUL® 201 (modified alkyl polyamide in naphthenic oil) (sold by Mobile Rosin Oil Company), PINEMUL® 300 (modified polyamide and tall oil) (sold by Mobile Rosin Oil Company) and PINEMUL® 302 (modified polyamide in naphthenic oil) (sold by Mobile Rosin Oil Company).

### Inorganic Salt

The aqueous phase can be water or a brine, i.e., an aqueous solution of an inorganic salt, such as a halide (e.g., F, Cl, Br or I) or hydroxide (OH) of an alkali (e.g., Li, Na, K) or alkaline earth metal (e.g., Mg, Ca, Ba), such as sodium chloride, potassium chloride, calcium hydroxide and calcium chloride.

### Alkaline Source

Suitable sources of an alkaline (>7) pH include, but are not limited to, lime (typically, calcium oxide and/or calcium hydroxide, but may include, for example, calcium carbonate and/or magnesium salts, such as magnesium carbonate), sodium hydroxide, potassium hydroxide, magnesium oxide (MgO). Such alkaline sources typically are used to bind or react with acidic gases such as CO₂ and H₂S.

### Additives

A weighting agent may be present. Suitable weighting agents include, but are not limited to, barite, barium sulfate, iron oxide, galena, siderite, magnetite, illmenite, celestite, dolomite, calcite, hematite and calcium carbonate. In a particular embodiment, the weighting agent is barite or barium sulfate.

A wetting agent may be present. Suitable wetting agents include, but are not limited to, lecithin, fatty acids, tall oil, oxidized tall oil, organic phosphate esters, modified imidazolines, modified amido-amines, alkyl aromatic sulfates, alkyl aromatic sulfonates and organic esters of polyhydric alcohols.

A fluid loss control additive agent may be present. Suitable fluid loss control additive agents include, but are not limited to, lignites, asphaltic compounds, gilsonite, organophilic humates and styrene-acrylic polymers such as PEXOTROL™ 552 (previously, PLIOLITE® DF) (sold by Omnova Solutions).

In an exemplary embodiment, the styrenic-acrylic polymeric rheological modifier includes organoclays, such as an organophilic clay, such as bentonite (an aluminium phyllosilicate clay consisting chiefly of montmorillonite), an organo-sepiolite clay, an organo-palygorskite clay (attapulgite) and hectorite clays. Hectorite is typically identified as a lithium magnesium sodium montmorillonite (as opposed to bentonite which is typically identified as a sodium calcium magnesium montmorillonite). In an exemplary embodiment, the organoclay is BENTONE® 155 (an organic modified bentonite clay) (sold by Elementis Global).

A gelling agent may be present. Suitable gelling agents include, but are not limited to, polysaccharide gelling agents (e.g., xanthan, scleroglucan, diutan, succinoglycan, locust bean gum, karaya gum, carboxymethyl cellulose guar gum, hydroxypropyl guar, 8-carboxymethylhydroxypropyl guar, and carboxymethyl-9 hydroxyethyl cellulose hydroxyethyl cellulose, and combinations thereof).

An organic liquid may be present. Water-miscible organic liquids may be present and include, but are not limited to, esters, amines, alcohols, polyols, glycol ethers, or combinations thereof. Examples of suitable esters include, but are not limited to, methylformate, methyl acetate, and ethyl acetate. Examples of suitable amines include, but are not limited to, diethyl amine, 2-aminoethanol, and 2-(dimethylamino)ethanol. Examples of suitable alcohols include, but are not limited to, methanol, ethanol, propanol, isopropanol, and the like. Examples of suitable glycol ethers include, but are not limited to, ethylene glycol butyl ether, diethylene glycol methyl ether, dipropylene glycol methyl ether, tripropylene glycol methyl ether, and the like.

Organic polymers may be present and include, but are not limited to, acrylic acid polymers, acrylic acid ester polymers, acrylic acid derivative polymers, acrylic acid homopolymers, acrylic acid ester homopolymers (such as poly(methyl acrylate), poly(butyl acrylate), and poly(2-ethylhexyl acrylate)), acrylic acid ester co-polymers, methacrylic acid derivative polymers, methacrylic acid homopolymers, methacrylic acid ester homopolymers (such as poly(methyl methacrylate), polyacrylamide homopolymer, N-vinyl pyrolidone and polyacrylamide copolymers, poly(butyl methacrylate), and poly(2-ethylhexyl methacrylate)), N-vinyl pyrolidone, acrylamido-methyl-propane sulfonate polymers, and combinations thereof. In an exemplary embodiment, the polymer comprises from approximately 0.1% to approximately 15% weight of the thermal insulating fluid.

### Oil Phase/Aqueous Phase

In an exemplary embodiment, the thermal insulating fluid is an invert emulsion, i.e., a water-in-oil emulsion comprising an external continuous oil phase in which is dispersed a discontinuous internal aqueous phase.

The aqueous phase may comprise fresh water, acidified water, salt water, seawater, brine, or an aqueous salt solution. The brine may be in the form of a monovalent brine or a divalent brine. Exemplary monovalent brines include, for example, sodium chloride brines, sodium bromide brines, potassium chloride brines, potassium bromide brines, and the like. Exemplary divalent brines include, for example, calcium chloride brines, calcium bromide brines, magnesium chloride brines, and the like.

In an exemplary embodiment, the ratio of oil:water ranges from approximately 50:50 to approximately 99:1, such as 70:30 to 99:1, such as 80:20 to 99:1, such as 90:10 to 99:1, such as 95:5 to 99:1, such as 97:3 to 99:1.

In an exemplary embodiment, the oil contained in the oil phase of the thermal insulating fluid is chosen from mineral oil, synthetic oil or diesel. The synthetic oil includes, but is not limited to, paraffin oils, iso-olefins, polyolefins and siloxane derivatives.

In an exemplary embodiment, the thermal insulating fluid is oil based and contains no water or only a de minimis amount of water.

### EXAMPLES

Exemplary Formulations 1-19 are shown below.

### Formulation 1

Formulation 01
Oil/Water Ratio 90/10

Product Concentration

| | Product | bbl/bbl | lb/bbl |
|---|---|---|---|
| 1 | Escald 110 | 0.5886 | 166.45 |
| 2 | Pinemul 100 | 0.0092 | 3.00 |
| 3 | Pinemul 300 | 0.0184 | 6.00 |
| 4 | Bentone 155 | 0.0168 | 10.00 |
| 5 | Lime | 0.0127 | 10.00 |
| 6 | 25% CaCl2 Brine | 0.1043 | 44.98 |
| 7 | Styrenic-Acrylic Copolymer | 0.2500 | 86.75 |

Rheological Properties

| | |
|---|---|
| 600 rpm reading @ 120° F. | >300 |

### Formulation 2

Formulation 02
Oil/Water Ratio 90/10

Product Concentration

| | Product | bbl/bbl | lb/bbl |
|---|---|---|---|
| 1 | Escald 110 | 0.6563 | 185.58 |
| 2 | Pinemul 100 | 0.0092 | 3.00 |
| 3 | Pinemul 300 | 0.0184 | 6.00 |
| 4 | Bentone 155 | 0.0034 | 2.00 |
| 5 | Lime | 0.0064 | 5.00 |
| 6 | 25% CaCl2 Brine | 0.1064 | 45.90 |
| 7 | Styrenic-Acrylic Copolymer | 0.2000 | 69.40 |

Rheological Properties

| | |
|---|---|
| 600 rpm reading @ 120° F. | >300 |

Formulation 3

Formulation 03
Oil/Water Ratio 95/5

Product Concentration

| | Product | bbl/bbl | lb/bbl |
|---|---|---|---|
| 1 | Escald 110 | 0.7116 | 201.24 |
| 2 | Pinemul 100 | 0.0092 | 3.00 |
| 3 | Pinemul 300 | 0.0184 | 6.00 |
| 4 | Bentone 155 | 0.0008 | 0.50 |
| 5 | Lime | 0.0064 | 5.00 |
| 6 | 25% CaCl2 Brine | 0.0536 | 23.10 |
| 7 | Styrenic-Acrylic Copolymer | 0.2000 | 69.40 |

Rheological Properties

| | |
|---|---|
| 600 rpm reading @ 120° F. | >300 |

### Formulation 4

Formulation 04
Oil/Water Ratio 95/5

Product Concentration

| | Product | bbl/bbl | lb/bbl |
|---|---|---|---|
| 1 | Escald 110 | 0.7124 | 201.46 |
| 2 | Pinemal 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0536 | 23.12 |
| 6 | Styrenic-Acrylic Copolymer | 0.2000 | 69.40 |

Rheological Properties

| | |
|---|---|
| 600 rpm reading @ 120° F. | >300 |

### Formulation 5

Formulation 05
Oil/Water Ratio 95/5

Product Concentration

| | Product | bbl/bbl | lb/bbl |
|---|---|---|---|
| 1 | Escaid 110 | 0.8124 | 229.74 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0536 | 23.12 |
| 6 | Styrenic-Acrylic Copolymer | 0.1000 | 34.70 |

Rheological Properties

| | |
|---|---|
| 600 rpm reading @ 120° F. | 200 |
| 300 rpm reading @ 120° F. | 150 |
| 200 rpm reading @ 120° F. | 117 |
| 100 rpm reading @ 120° F. | 72 |
| 6 rpm reading @ 120° F. | 13 |
| 3 rpm reading @ 120° F. | 11 |

### Formulation 6

Formulation 06
Oil/Water Ratio 99/1

Product Concentration

| | Product | bbl/bbl | lb/bbl |
|---|---|---|---|
| 1 | Escaid 110 | 0.7553 | 213.58 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0108 | 4.64 |
| 6 | Styrenic-Acrylic Copolymer | 0.2000 | 69.40 |

Rheological Properties
Yield Stress = 58.7 lb/100 ft²

| | |
|---|---|
| 600 rpm reading @ 120° F. | >300 |
| 300 rpm reading @ 120° F. | >300 |
| 200 rpm reading @ 120° F. | >300 |
| 100 rpm reading @ 120° F. | >300 |
| 10 rpm reading @ 120° F. | 145 |
| 6 rpm reading @ 120° F. | 127 |
| 1 rpm reading @ 120° F. | 88 |

Yield Stress = 71.6 lb/100 ft²

| | |
|---|---|
| 600 rpm reading @ 150° F. | >300 |
| 300 rpm reeding @ 150° F. | >300 |
| 200 rpm reading @ 150° F. | >300 |
| 100 rpm reading @ 150° F. | 276 |
| 10 rpm reading @ 150° F. | 117 |
| 6 rpm reading @ 150° F. | 107 |
| 1 rpm reading @ 150° F. | 81 |

Formulation 7. Formulation 7 represents a changing of the order of addition of Formulation 6 and also eliminates the water fraction of the brine.

Formulation 07
Oil/Water Ratio 99.99/0.01

Product Concentration

| | Product | bbl/bbl | lb/bbl |
|---|---|---|---|
| 1 | Escaid 110 | 0.7643 | 216.15 |
| 2 | Styrenic-Acrylic Copolymer | 0.2000 | 69.40 |
| 3 | CaCl2 | 0.0016 | 1.20 |
| 4 | Pinemul 100 | 0.0092 | 3.00 |
| 5 | Pinemul 300 | 0.0184 | 6.00 |
| 6 | Lime | 0.0064 | 5.00 |
| 7 | Water | 0.0001 | 0.03 |

Formulation 8. Formulation 8 keeps the same order of addition of Formulation 6 but eliminates the water fraction of the brine.

Formulation 08
Oil/Water Ratio 99.99/0.01

Product Concentration

| | Product | bbl/bbl | lb/bbl |
|---|---|---|---|
| 1 | Escaid 110 | 0.7643 | 216.15 |
| 2 | Pinemul 100 | 0.0092 | 3.00 |
| 3 | Pinemul 300 | 0.0184 | 6.00 |
| 4 | Lime | 0.0064 | 5.00 |
| 5 | CaCl2 | 0.0016 | 1.20 |
| 6 | Styrenic-Acrylic Copolymer | 0.2000 | 69.40 |

### Formulation 9

Formulation 09
Oil/Water Ratio 95/5

Product Concentration

| | Product | bbl/bbl | lb/bbl |
|---|---|---|---|
| 1 | Escaid 110 | 0.7624 | 215.60 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0536 | 23.12 |
| 6 | Styrenic-Acrylic Copolymer | 0.1500 | 52.05 |

Rheological Properties

| | |
|---|---|
| 600 rpm reading @ 120° F. | >300 |

Formulation 10. Mixing was accomplished by a multimixer (manufacturer OFITE) operated at a rotational speed of 11,500 rpm.

Formulation 10
Oil/Water Ratio 99/1

Product Concentration

| | Product | bbl/bbl | lb/bbl |
|---|---|---|---|
| 1 | Escaid 110 | 0.8053 | 227.72 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0108 | 4.64 |
| 6 | Styrenic-Acrylic Copolymer | 0.1500 | 52.05 |

Rheological Properties

| | |
|---|---|
| 600 rpm reading @ 120° F. | 225 |
| 600 rpm reading @ 150° F. | 200 |

Formulation 10R. The same formulation as Formulation 10 but the overhead mixer was operated at a rotational speed of 505 rpm.

Formulation 10R
Oil/Water Ratio 99/1

Product Concentration

| | Product | bbl/bbl | lb/bbl |
|---|---|---|---|
| 1 | Escaid 110 | 0.8053 | 227.72 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0108 | 4.64 |
| 6 | Styrenic-Acrylic Copolymer | 0.1500 | 52.05 |

| | |
|---|---|
| Activation Time | >5 Hrs |

Properties

| | | Static Aging |
|---|---|---|
| | Initial | 16 Hrs. At 75° F. |
| 600 rpm reading @ 120° F. | 61 | 271 |
| 300 rpm reading @ 120° F. | 42 | 225 |
| 200 rpm reading @ 120° F. | 32 | 199 |
| 100 rpm reading @ 120° F. | 21 | 156 |
| 6 rpm reading @ 120° F. | 6 | 40 |
| 3 rpm reading @ 120° F. | 5 | 35 |
| 1 rpm reading @ 120° F. | 4 | 22 |

### Formulation 11

Formulation 11
Oil/Water Ratio 95/5

Product Concentration

| | Product | bbl/bbl | lb/bbl |
|---|---|---|---|
| 1 | Escaid 110 | 0.7287 | 206.06 |
| 2 | Pinemul 100 | 0.0460 | 15.00 |
| 3 | Pinemul 300 | 0.0153 | 5.00 |
| 4 | Lime | 0.0064 | 5.00 |
| 5 | 25% CaCl2 Brine | 0.0536 | 23.12 |
| 6 | Styrenic-Acrylic Copolymer | 0.1500 | 52.05 |

Rheological Properties
Yield Stress = 72.6 lb/100 ft²

| | |
|---|---|
| 600 rpm reading @ 120° F. | >300 |
| 300 rpm reading @ 120° F. | >300 |
| 200 rpm reading @ 120° F. | >300 |
| 100 rpm reading @ 120° F. | >300 |
| 10 rpm reading @ 120° F. | 137 |
| 6 rpm reading @ 120° F. | 123 |
| 1 rpm reading @ 120° F. | 90 |

Yield Stress = 77.5 lb/100 ft²

| | |
|---|---|
| 600 rpm reading @ 150° F. | >300 |
| 300 rpm reading @ 150° F. | >300 |
| 200 rpm reading @ 150° F. | >300 |
| 100 rpm reading @ 150° F. | 300 |
| 10 rpm reading @ 150° F. | 123 |
| 6 rpm reading @ 150° F. | 111 |
| 1 rpm reading @ 150° F. | 85 |

### Formulation 12

Formulation 12
Oil/Water Ratio 95/5

Product Concentration

| | Product | bbl/bbl | lb/bbl |
|---|---|---|---|
| 1 | Escaid 110 | 0.7287 | 206.06 |
| 2 | Pinemul 100 | 0.0153 | 5.00 |
| 3 | Pinemul 300 | 0.0460 | 15.00 |
| 1 | Lime | 0.0064 | 5.00 |
| 5 | 25% CaCl2 Brine | 0.0536 | 23.12 |
| 6 | Styrenic-Acrylic Copolymer | 0.1500 | 52.05 |

Properties

| | | Static Aging | Static Aging |
|---|---|---|---|
| | Initial | 16 Hrs. At 75° F. | 4 Days At 75° F. |
| 600 rpm reading @ 120° F. | >300 | >300 | >300 |
| 600 rpm reading @ 150° F. | >300 | >300 | >300 |
| 100 rpm reading @ 120° F. | 218 | 241 | >300 |
| 60 rpm reading @ 120° F. | 169 | 186 | 249 |
| 10 rpm reading @ 120° F. | 89 | 99 | 119 |
| 6 rpm reading @ 120° F. | 79 | 90 | 105 |
| 1 rpm reading @ 120° F. | 60 | 67 | 71 |

### Formulation 13

Formulation 13
Oil/Water Ratio 95/5

Product Concentration

| | Product | bbl/bbl | lb/bbl |
|---|---|---|---|
| 1 | Escald 110 | 0.8124 | 229.74 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0536 | 23.12 |
| 6 | Styrenic-Acrylic Copolymer | 0.1000 | 34.70 |

Properties

| | | 2 Hrs | | After Static | | |
|---|---|---|---|---|---|---|
| | Initial | After Mixing | | Aging at 250° F. | | |
| | 120° | 120° | 150° | 70° | 120° | 150° |
| | F. | F. | F. | F. | F. | F. |
| 600 rpm reading | 190 | 250 | 172 | >300 | >300 | >300 |
| 300 rpm reading | 133 | 190 | 107 | 297 | >300 | 273 |
| 200 rpm reading | 105 | 154 | 80 | 275 | >300 | 216 |
| 100 rpm reading | 67 | 100 | 48 | 233 | 293 | 127 |
| 6 rpm reading | 15 | 18 | 10 | 88 | 29 | 7 |
| 3 rpm reading | 12 | 13 | 8 | 70 | 13 | 5 |
| Plastic viscosity, cP | 57 | 60 | 65 | — | — | — |
| Yield point, lb/100 ft² | 76 | 130 | 42 | — | — | — |
| 10-sec Gel, lb/100 ft² | 12 | 13 | 7 | 88 | 12 | 4 |
| 10-Min Gel, lb/100 ft² | 31 | 37 | 23 | 158 | 15 | 4 |

### Formulation 14

Formulation 14
Oil/Water Ratio 95/5

Product Concentration

| | Product | bbl/bbl | lb/bbl |
|---|---|---|---|
| 1 | Diesel | 0.7287 | 214.54 |
| 2 | Pinemul 100 | 0.0460 | 15.00 |
| 3 | Pinemul 300 | 0.0153 | 5.00 |
| 4 | Lime | 0.0064 | 5.00 |
| 5 | 25% CaCl2 Brine | 0.0536 | 23.12 |
| 6 | Styrenic-Acrylic Copolymer | 0.1500 | 52.05 |

Rheological Properties
Yield Stress = 19.69 lb/100 ft²

| | |
|---|---|
| 600 rpm reading @ 120° F. | 282 |
| 300 rpm reading @ 120° F. | 192 |
| 200 rpm reading @ 120° F. | 150 |
| 100 rpm reading @ 120° F. | 103 |
| 10 rpm reading @ 120° F. | 43 |
| 6 rpm reading @ 120° F. | 38 |
| 1 rpm reading @ 120° F. | 20 |

Yield Stress = 47.2 lb/100 ft²

| | |
|---|---|
| 600 rpm reading @ 150° F. | >300 |
| 300 rpm reading @ 150° F. | >300 |
| 200 rpm reading @ 150° F. | >300 |
| 100 rpm reading @ 150° F. | 261 |
| 60 rpm reading @ 150° F. | 212 |
| 10 rpm reading @ 150° F. | 106 |
| 6 rpm reading @ 150° F. | 96 |
| 3 rpm reading @ 150° F. | 83 |
| 1 rpm reading @ 150° F. | 65 |

### Formulation 15

Formulation 15
Oil/Water Ratio 70/30

Product Concentration

| | Product | bbl/bbl | lb/bbl |
|---|---|---|---|
| 1 | Escaid 110 | 0.5172 | 146.26 |
| 2 | Pinemul 100 | 0.0460 | 15.00 |
| 3 | Pinemul 300 | 0.0153 | 5.00 |
| 4 | Lime | 0.0064 | 5.00 |
| 5 | 25% CaCl2 Brine | 0.3151 | 135.91 |
| 6 | Styrenic-Acrylic Copolymer | 0.1000 | 34.70 |

Properties

| | 120° F. | 150° F. |
|---|---|---|
| 600 rpm reading @ 120° F. | >300 | >300 |
| 300 rpm reading @ 120° F. | >300 | >300 |
| 200 rpm reading @ 120° F. | >300 | >300 |
| 100 rpm reading @ 120° F. | 215 | >300 |
| 10 rpm reading @ 120° F. | 99 | >300 |
| 6 rpm reading @ 120° F. | 92 | 280 |
| 1 rpm reading @ 120° F. | 82 | 211 |

### Formulation 16

Formulation 16
Oil/Water Ratio 70/30

Product Concentration

| | Product | bbl/bbl | lb/bbl |
|---|---|---|---|
| 1 | Escaid 110 | 0.4672 | 132.12 |
| 2 | Pinemul 100 | 0.0460 | 15.00 |
| 3 | Pinemul 300 | 0.0153 | 5.00 |
| 4 | Lime | 0.0064 | 5.00 |
| 5 | 25% CaCl2 Brine | 0.3151 | 135.91 |
| 6 | Styrenic-Acrylic Copolymer | 0.1500 | 52.05 |

Properties

| | 120° F. | 150° F. |
|---|---|---|
| 600 rpm reading | >300 | >300 |
| 300 rpm reading | >300 | >300 |
| 200 rpm reading | >300 | >300 |
| 100 rpm reading | >300 | >300 |
| 10 rpm reading | >300 | >300 |
| 6 rpm reading | 286 | >300 |
| 1 rpm reading | 245 | >300 |

### Formulation 17

Formulation 17
Oil/Water Ratio 99/1

Product Concentration

| | Product | bbl/bbl | lb/bbl |
|---|---|---|---|
| 1 | Escaid 110 | 0.9059 | 256.19 |
| 2 | Pinemul 100 | 0.0092 | 3.00 |
| 3 | Pinemul 300 | 0.0184 | 6.00 |
| 4 | Lime | 0.0064 | 5.00 |
| 5 | 25% CaCl2 Brine | 0.0102 | 4.41 |
| 6 | Styrenic-Acrylic Copolymer | 0.0499 | 18.00 |

Properties

| | 120° F. | 150° F. |
|---|---|---|
| 600 rpm reading | 8.2 | 8.7 |
| 300 rpm reading | 4.1 | 4.1 |
| 200 rpm reading | 2.1 | 2.8 |
| 100 rpm reading | 1.3 | 1.3 |
| 10 rpm reading | 0.2 | 0.2 |
| 6 rpm reading | 0.2 | 0.2 |
| 1 rpm reading | 0.2 | 0.2 |

### Formulation 18

Formulation 18
Oil/Water Ratio 100/0

| | | Product Concentration |
|---|---|---|
| | Product | (lb/bbl) |
| 1 | Escaid 110 | 0.9059 |
| 2 | Pinemul 100 | 0.0092 |
| 3 | Pinemul 300 | 0.0184 |
| 4 | Lime | 0.0064 |
| 5 | 25% CaCl2 Brine | 0.0102 |
| 6 | Styrenic-Acrylic Copolymer | 0.0499 |

Properties

| | 120° F. | 150° F. |
|---|---|---|
| 600 rpm | 8.2 | 8.7 |
| 300 rpm | 4.1 | 4.1 |
| 200 rpm | 2.1 | 2.8 |
| 100 rpm | 1.3 | 1.3 |
| 10 rpm | 0.2 | 0.2 |
| 6 rpm | 0.2 | 0.2 |
| 1 rpm | 0.2 | 0.2 |

### Formulation 19

Formulation 19
Oil/Water Ratio 100/0

Product Concentration

| | Product | lb/bbl |
|---|---|---|
| 1 | Escaid 110 | 227.72 |
| 2 | Pinemul 100 | 15.00 |
| 3 | Pinemul 300 | 5.00 |
| 4 | Lime | 5.00 |
| 5 | Styrenic-Acrylic Copolymer | 52.05 |
| 6 | CaCl, Salt (Powder) | 20.00 |

Rheological Properties
Yield Stress = 26.0 lb/100 ft²

| | |
|---|---|
| 600 rpm reading @ 120° F. | >300 |
| 300 rpm reading @ 120° F. | 288 |
| 200 rpm reading @ 120° F. | 222 |
| 100 rpm reading @ 120° F. | 143 |
| 10 rpm reading @ 120° F. | 49 |
| 6 rpm reading @ 120° F. | 41 |
| 3 rpm reading @ 120° F. | 33 |
| 2 rpm reading @ 120° F. | 30 |
| 1 rpm reading @ 120° F. | 26 |

Yield Stress = 14.9 lb/100 ft²

| | |
|---|---|
| 600 rpm reading @ 150° F. | 257 |
| 300 rpm reading @ 150° F. | 165 |
| 200 rpm reading @ 150° F. | 130 |
| 100 rpm reading @ 150° F. | 88 |
| 10 rpm reading @ 150° F. | 30 |
| 6 rpm reading @ 150° F. | 25 |
| 3 rpm reading @ 150° F. | 20 |
| 2 rpm reading @ 150° F. | 18 |
| 1 rpm reading @ 150° F. | 15 |

### DISCUSSION

Formulations 1-3 represent exemplary formulations of the thermal insulating fluid of the invention containing a styrenic-acrylic polymeric rheological modifier in combination with an organophilic clay (BENTONE® 155).

Formulations 4-6 represent exemplary formulations of the thermal insulating fluid of the invention containing the styrenic-acrylic polymeric rheological modifier as the only rheological modifier (i.e., with no organoclays present).

Formulations 7-8 represent exemplary formulations of the thermal insulating fluid of the invention containing a styrenic-acrylic polymeric rheological modifier that reflect the impact of the order of addition of the components of the formulation on the rheological profiles of the final thermal insulating fluid products.

Formulations 9-10 represent exemplary formulations of the thermal insulating fluid of the invention containing a styrenic-acrylic polymeric rheological modifier that reflect the impact of the oil:water ratio on the rheological profiles of the final thermal insulating fluid products.

Formulations 10 and 10R represent exemplary formulations of the thermal insulating fluid of the invention containing a styrenic-acrylic polymeric rheological modifier that reflect the impact of the speed of mixing the components on the rheological profiles of the final thermal insulating fluid products.

Formulations 11-12 represent exemplary formulations of the thermal insulating fluid of the invention containing a styrenic-acrylic polymeric rheological modifier that reflect the impact of changing the relative amounts of the emulsifiers present on the rheological profiles of the final thermal insulating fluid products.

Formulation 13 reflects the impact of reducing the load level of a styrenic-acrylic polymeric rheological modifier (compared to, e.g., Formulation 4) on the rheological profile of the final thermal insulating fluid products.

Formulation 14 reflects impact of replacing the mineral base oil (Escaid™ 110) with (#2 diesel oil) (compared to, e.g., Formulation 11) on the rheological profile of the final thermal insulating fluid products.

Formulations 15-16 represent exemplary formulations of the thermal insulating fluid of the invention containing a styrenic-acrylic polymeric rheological modifier that reflect the impact of decreasing the oil:water ratio (compared to, e.g., Formulation 11) and reducing the load level of the styrenic-acrylic polymeric rheological modifier on the rheological profiles of the final thermal insulating fluid products.

Formulation 17 reflects the impact of replacing a styrenic-acrylic copolymer containing para-tert-butyl-styrene with a styrenic-acrylic copolymer containing a mixture of para-tert-butyl-styrene and para-methyl-styrene.

Formulation 18 reflects the impact of eliminating water from an oil-water formulation of the thermal insulating fluid of the invention (i.e., has an oil:water ratio of (100:0)) where the added aqueous phase was eliminated from the formulation.

Formulation 19 reflects the impact of adding the styrenic-acrylic copolymer as a dry powder (i.e., no aqueous portion is present in the rheological modifier).

The invention as described is intended to cover not only individual aspects or exemplary embodiments of the invention but also combinations of all aspects and embodiments.

1. A thermal insulating fluid comprising:
(a) a styrenic-acrylic polymeric rheological modifier;
(b) a hydrocarbon fluid;
(c) optionally a first emulsifier;
(d) optionally an inorganic salt;
(e) optionally an alkaline source;
(f) optionally a second emulsifier; and
(g) optionally an aqueous phase,
wherein the thermal insulating fluid is a yield power law fluid.

2. The thermal insulating fluid according to claim 1, wherein the styrenic-acrylic polymeric rheological modifier contains a styrene-based monomer substituted on the phenyl moiety, chosen from meta-methyl-styrene, para-methyl-styrene, para-propyl-styrene, para-tert-butyl-styrene, para-cyclohexyl-styrene, para-dodecyl-styrene, 2-ethyl-4-benzyl-styrene, para-(phenylbutyl)-styrene, and mixtures thereof.

3. The thermal insulating fluid according to claim 1, wherein the thermal insulating fluid exhibits a yield stress of higher than 10 lb_{f}/100 ft² (5 Pa), more particularly of higher than 20 lb_{f}/100 ft² (19 Pa) and even more particularly of higher than 60 lb_{f}/100 ft² (30 Pa).

4. The thermal insulating fluid according to claim 1, wherein the first emulsifier is present and is selected from rosin acids, tall oil acids, fatty alcohols, fatty acids, salts thereof, polyamides, and combinations thereof.

5. The thermal insulating fluid according to claim 1, wherein the hydrocarbon fluid is selected from diesels, paraffin oils, mineral oil, crude oils, kerosene, and combinations thereof.

6. The thermal insulating fluid according to claim 1, wherein the hydrocarbon fluid comprises a mineral oil.

7. The thermal insulating fluid according to claim 1, wherein the inorganic salt is present and is an alkali salt or an alkaline earth salt.

8. The thermal insulating fluid according to claim 1, wherein the alkaline source is present and is a calcium salt, a magnesium salt or a combination thereof.

9. The thermal insulating fluid according to claim 1, wherein the aqueous phase is present and is selected from fresh water, acidified water, seawater and brine.

10. The thermal insulating fluid according to claim 1, wherein the aqueous phase is present in a ratio of oil:water of from 50:50 to 99:1.

11. The thermal insulating fluid according to claim 1, wherein the thermal insulating fluid is an invert emulsion.

12. The thermal insulating fluid according to claim 1, wherein the thermal insulating fluid does not contain an aqueous phase.

13. The thermal insulating fluid according to claim 1, comprising:
(a) a styrenic-acrylic polymeric rheological modifier;
(b) a hydrocarbon fluid;
(d) optionally an inorganic salt; and
(e) optionally an alkaline source,
wherein the thermal insulating fluid does not contain an aqueous phase.

14. The thermal insulating fluid according to claim 1, comprising:
(a) a styrenic-acrylic polymeric rheological modifier;
(b) a hydrocarbon fluid;
(c) a first emulsifier;
(d) optionally an inorganic salt;
(e) optionally an alkaline source; and
(g) an aqueous phase.

15. A process for preparing the thermal insulating fluid according to claim 1, comprising mixing together the styrenic-acrylic polymeric rheological modifier; the hydrocarbon fluid; and optionally one or more of the first emulsifier, the inorganic salt the alkaline source, and the second emulsifier.

16. The process according to claim 15, wherein the hydrocarbon fluid is added first.

17. A method for adding a thermal insulating fluid into an annulus, comprising adding the thermal insulating fluid according to claim 1 into one or more annuli.

18. The method according to claim 17, wherein the annulus is positioned between a first tubing and a second tubing.

19. The method according to claim 17, wherein a tubing containing a fluid located within a wellbore is provided such that the annulus is formed between the tubing and a surface of the wellbore.

20. An annulus of a well containing the thermal insulating fluid according to claim 1.
